(19) United States
(12) Patent Application Publication
(10) Pub. No.: US 2013/0169707 A1
(43) Pub. Date: Jul. 4, 2013

(54) Advanced Ultra-Compact High Performance Projector System and Imaging Lens Arrangement for Use Therein

(71) Applicants: Lin Li, Boise, ID (US); Bradley Sissom, Boulder, CO (US); Kirk Cook, Lyons, CO (US)

(72) Inventors: Lin Li, Boise, ID (US); Bradley Sissom, Boulder, CO (US); Kirk Cook, Lyons, CO (US)

(21) Appl. No.: 13/341,740

(22) Filed: Dec. 30, 2011

(51) Int. Cl. G09G 5/02; G02B 9/34; G02B 27/12

(52) U.S. Cl. 345/697; 359/629; 359/650

(57) ABSTRACT

An imaging lens arrangement and method have been described for use with an imaging projector system including a display. A plurality of no more than four lenses can be arranged to receive an object image that emits from the display to propagate through the plurality of lenses to produce a high-resolution projected image from the object image. The imaging projector system has compact configuration, low height profile and provides high performance.

### BACKGROUND

The present invention is generally related to the field of projector systems and, more particularly, to the field of ultra compact high performance projector systems.

Expanding use of computers, handheld devices, tablets and other computation electronic devices is rapidly fueling increasing production, viewing and sharing of videos as well as stationary images, especially including digitized images that can be displayed, stored and transferred based on digital electronic signals.

While conventional displays, such as LCD panels, are commonly utilized as visual monitors for desktop and/or laptop computers, projector systems are sometimes employed, typically as external peripheral devices, to serve as an auxiliary display that can be advantageous at least in certain applications. In many cases, a given projector system may be configured, as an external peripheral device, to provide at least a reasonably portable means for projecting a video and/or stationary image that is substantially larger than the projector system. For example, high performance projector systems commonly employed in the context of business meetings, sales pitches and presentations, may be of sufficiently small overall size for at least reasonably convenient transport by way of a briefcase, and may be capable of displaying high quality and high brightness images on a projection screen. These projectors may be configured to produce the projected image in response to an electronic signal from computers and many other electronic devices.

There are numerous well known configurations of traditional projector systems, many of which include some type of projection lens arrangement that can be configured to receive an object image and to produce a projected image responsive thereto. As will be described hereinafter; the projection lens arrangement may be instrumental in defining, or at least influencing various performance specifications for a given projector system. In this regard, Applicants recognize that traditional approaches are limited with respect to the competing interests of miniaturization in conjunction with providing high quality projected images.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic plan view of a high performance ultra-compact projector system.

FIG. 2A is a diagrammatic plan view of an embodiment of an imaging lens arrangement for use with the ultra-compact projector system of FIG. 1.

FIG. 2B is a diagrammatic elevational view of a display.

FIG. 3 is a graphical representation of modulation transfer function (MTF) characteristics associated with the imaging lens arrangement of FIG. 2A.

FIG. 4 is a graphical representation of distortion characteristics associated with the imaging lens arrangement of FIG. 2A.

FIG. 5 illustrates a plot of relative intensity associated with the imaging lens arrangement of FIG. 2A.

FIG. 6 is a diagrammatic plan view illustrating further details with respect to the ultra-compact projector system of FIG. 1.

FIGS. 7A is a diagrammatic perspective view of a light pipe.

FIG. 7B is a diagrammatic elevational view of a light source arrangement.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

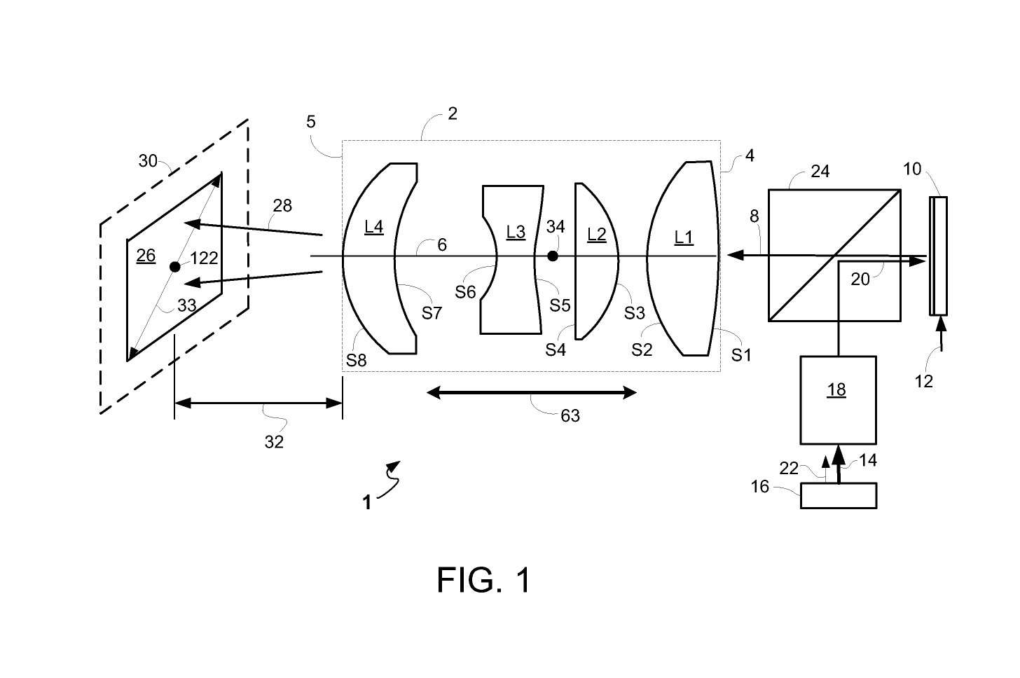

Attention is now directed to the figures wherein like reference numbers may refer to like components throughout the various views. FIG. 1 is a diagrammatic view, in elevation, of an embodiment of a projector system, produced according to the present disclosure, and generally indicated by reference number 1. Projector system 1 includes an imaging lens arrangement 2, indicated within a dashed box, generally defining an entrance side 4 and an exit side 5. As will be described in greater detail hereinafter, an embodiment of the projector system includes a plurality of lenses with an input lens L1 serving as entrance side 4, and an exit lens L4 serving as exit side 5 of the imaging lens arrangement, with lenses L2 and L3 disposed therebetween. The imaging lens arrangement defines an optical axis 6 and receives an object image 8, indicated in the figure using an arrow that emits from a display 10. The display may be a pixilated LCOS display that can be illuminated by approximately uniform light 20, at least having approximately uniform intensity, causing the display to emit object image 8 responsive to an electronic signal 12. Initial non-uniform light 14 may be initially produced by a light source arrangement 16, and subsequently received by a homogenizer arrangement 18, which may spatially homogenize initial light 14 to produce at least approximately uniform light 20 having at least approximately uniform intensity at least with respect to illumination of the display. While the output from the homogenizer arrangement may initially propagate in a given direction 22, and while uniform light 20 may not initially be directed toward the display, this uniform light may be received by a beamsplitter 24 and redirected for incidence onto a major surface of display 10. Based on well known principles of optics, the beamsplitter may be a polarizing beamsplitter cube configured such that a majority of uniform light 20 is redirected towards the display. Furthermore, a majority of light forming object image 8, may exhibit a polarization that is appropriately oriented to pass straight through the beamsplitter for reception by imaging lens arrangement 2. Imaging lens arrangement 2 may be configured to receive object image 8 which propagates through imaging lens arrangement 2 to produce a projected image 26, based on projected light 28, that exits the imaging lens arrangement from exit side 5 and may come into focus on image plane 30 at an image distance 32 indicated in the figure using a double-headed arrow. It should be appreciated that the lateral extents of the projected image can vary depending in part oh image distance 32. Consistent with well known conventions, the lateral extent of projected image may be characterized at least in part by a diagonal extent 33, indicated in FIG. 1 using a double headed arrow.

In the context of projector system 1, imaging lens arrangement 2 may limit or otherwise define various projector specifications, relating to a projected image quality, including but not limited to MTF (Modulation Transfer Function), total distortion, intensity uniformity, lateral color, depth of focus, projected image size and image brightness. Further details with respect to imaging lens arrangement 2 will be provided at appropriate points hereinafter.

For purposes of clarification, in the context of this disclosure, a given embodiment of projector system 1, can be generally considered as a high performance projector system, projecting high quality images, at least insofar as that embodiment provides for
a) Large size projected images having sufficient height and width for easy viewing at least by several people simultaneously, from a distance such that the people can avoid crowding amongst one another.
b) High brightness that is sufficient for easy viewing under typical conditions of ambient lighting that may be found indoors and/or outside under conditions of heavy shade.
c) Projected images having sufficiently low distortion, for example less than 1.0% throughout the majority of projected image 26, such that a typical person, when viewing the given projected image cannot readily discern the influence of distortion.
d) Sufficiently high MTF, for example greater than 30%, such that any person with normal to excellent vision, upon viewing a typical image from a close up perspective, can at least barely discern individual display pixels in the projected image.
e) A high degree of uniformity with respect to intensity of the projected image, for example, less than 20% intensity variation at least for cases where the image is projected responsive to a uniform object image emitted by the display.
f) A generally desirable throw ratio (image distance/image width) for example a throw ratio in a range from 0.8:1 to 2:, such that the enlarged projection images can be shown on a screen which is not too far, at least for practical purposes, from the projection system.

Applicants appreciate that satisfaction of certain ones of the foregoing projector specifications, with conventional projector systems as well as in the disclosed embodiment, may depend to a large extent on the imaging lens system. For example, projection of images satisfying a specific criterion for MTF may depend almost entirely on characteristics of the imaging lens system. However, satisfying certain other specifications may require cooperation, perhaps in complex ways, between the imaging lens system and other components of the projector system. For example, in the embodiment at hand, satisfying a predetermined specification for brightness of projected images; may call for at least somewhat complex cooperation between the light source arrangement and the imaging lens system. In particular, for the projector to project predetermined large size images; while at the same time providing a predetermined high brightness, even in the case of an embodiment that utilizes a state of the art high brightness light source arrangement, it may be of benefit for the lens system to exhibit an f-number sufficiently low such that the lens system does not excessively limit the amount of light available from the light source arrangement. In some cases, the selected light source arrangement may represent the brightest source that is reasonably available and/or compatible with the configuration at hand. While the imaging lens system is not to be considered as the sole influence defining the brightness of the projector system, a low f-number imaging lens system may be regarded as a characteristic for influencing the brightness of the projector system.

Still considering cooperation between the imaging lens arrangement and other portions of the projector system, there may be yet more complex tradeoffs between various conflicting design specifications, including but not limited to the conflicting goals of achieving higher brightness while achieving a predetermined high image quality with the projection system having a lower overall system height and fewer components. In some embodiments, enhanced MTF of the projected image may be provided in part by introducing an aperture arrangement, as part of and imaging lens system, that confines passage of the input image, as the input image propagates through the lens arrangement, to a series of aperture windows each having an aperture size and shape that is characterized in part by an aperture height. Thus, the aperture arrangement may be defined at least in part by a clear aperture associated with each one of at least a subset of the lenses. Furthermore, as will be described hereinafter, a lens having a clear aperture size may be truncated such that the clear aperture height of that lens is reduced as compared to the clear aperture width. In the case of a truncated lens, the clear aperture height may be regarded as being truncated with respect to the clear aperture size of that lens, while the clear aperture width may be considered as being the same as the clear aperture size for that lens. In embodiments where a given lens is not truncated, the clear aperture height may be the same as the clear aperture size. In cases where the clear aperture of one or more lenses, truncated or otherwise confines passage of the image, the lenses themselves can be regarded as defining at least part of the aperture arrangement. Further confinement may be provided, as part of the aperture arrangement, by introducing an aperture-stop such as a plate that defines a hole. In any embodiment that includes an aperture-stop, the aperture arrangement may be defined in part by the clear apertures of one or more of the lenses and in part by the aperture-stop. In various embodiments, to be described at appropriate points hereinafter, the hole defined by the aperture-stop may be circular. The aperture arrangement may be configured, to enhance MTF performance such that an MTF of the output image is higher as compared to a different MTF that would be exhibited without the aperture arrangement. It is noted that the aperture arrangement; while improving MTF of the projected image, may also impose a tradeoff between brightness and MTF, and that this tradeoff may be balanced against other design considerations. It is further noted that the foregoing description is not intended as being limiting, and Applicants recognize that the described tradeoff is but one of many possible design tradeoffs that may be considered, depending on the embodiment. Moreover, there may be other aspects and/or tradeoffs with respect to achieving a desired target value and/or range of MTF values associated with projected image 26.

As described in the background section, one common characteristic shared by many projector systems, is a capability to project an image that is significantly larger than the overall size of the projector. As each generation of handheld devices provides greater computational power than the last, Applicants consider that the limitations of conventional built-in displays such as small size LCD panels can be regarded as being increasingly restrictive of the full potential usefulness for devices. In this regard, Applicants disclose herein high performance projectors sufficiently compact enough and with sufficiently low height profile to fit within present and future handheld devices, such as smart phones, while still offering heretofore unseen performance.

As briefly described above, satisfaction of certain specifications associated with a high performance projector may depend at least generally on characteristics of the imaging lens system alone, while satisfying other specifications may require complex cooperation between the imaging lens system and other components of the projector system. In both cases, Applicants appreciate that a requirement for sufficient compactness, for a high performance projector to fit into typical handheld devices, can exacerbate practical difficulties associated with all of the listed specifications. Any high performance projector, configured for projecting images at least generally consistent with high performance characteristics, and small enough to fit within currently available and future handheld devices, may hereinafter referred as an ultra compact high performance projector system.

As Applicants have developed projector designs having ever smaller overall size and lower cost, it has been recognized that, absent the luxury of a reasonable and traditional amounts of space to work within, the challenges associated with ultra-compact high performance projector design tend to reach beyond the scope of traditional projector design techniques. In this regard, traditional design approaches cannot be reasonably modified to meet the requirements at hand. Applicants believe that a person of ordinary skill in the art, including even the most skilled and specialized practitioners, not having access to the disclosure at hand, would in many cases regard the practical and conceptual difficulties of designing and producing such a compact high performance projector system as being sufficiently challenging as to at best render uncertain the practicality of such a proposal. Furthermore, Applicants believe that a person of ordinary skill in the art, in the course of such attempts at miniaturization of a conventional projector system, would be likely to introduce design compromises that would tend to degrade performance to such a degree as to render systems that are, at least from Applicants perspective, not suitable for use as compact high performance projection systems. At least in this regard, Applicants believe that recognition of the combined challenges and tradeoffs, and the design and production of ultra compact projector systems for high-resolution displays would tend to be beyond the capability of a person of ordinary skill in the art not having this disclosure in hand.

Still referring to FIG. 1, Applicants disclose herein embodiments of a high performance and compact imaging lens arrangement, for use in ultra compact and high performance embodiments of projector system 1, having a sufficiently low height profile, defined in part by restrictions of lens height, to fit within the thickness of many current hand held devices. Iri particular, one embodiment utilizes four lenses, L1=L4 as seen in FIG. 1, each lens having a clear aperture size of no more than 10.0 mm, and each lens having a clear aperture height in a direction shown as height 34, at least generally orthogonal to the plane of the figure, as indicated in the figure by a dot. As described above, clear aperture size and height are not always the same, at least for the reason that the clear aperture height of one or more lenses may be truncated with respect to the clear, aperture size of that lens. It is noted that the dot, indicated as height 34, is intended as being representative of spatial extent perpendicular to the plane of the figure, and this illustrative convention may be applied with reference to various heights throughout the remainder of this disclosure. In spite of this limited lens height, the present embodiment can be utilized in combination with available light source arrangements and display panels, also of low height profile, to project large high quality images in accordance with characteristics that are brought to light immediately hereinafter, in conjunction with an initial description of the disclosed embodiment.

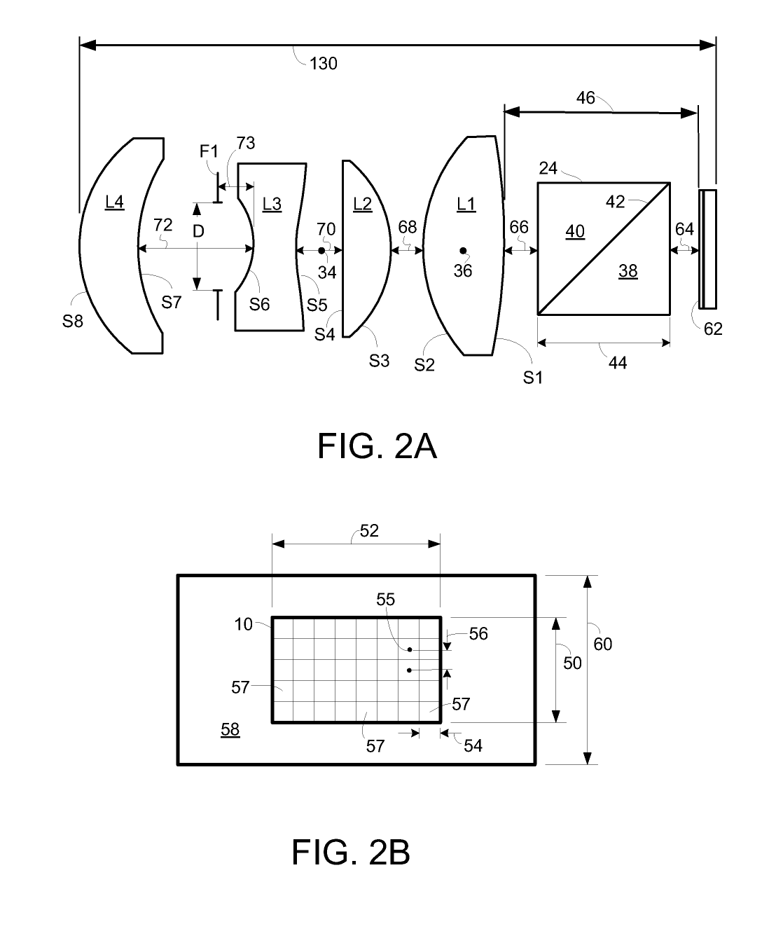

Attention is now turned to FIG. 2A, with ongoing reference to FIG. 1. FIG. 2A is a schematic diagram illustrating further details of an embodiment of high performance compact imaging lens arrangement 2 of FIG. 1. For purposes of illustrative clarity, previously described beamsplitter 24 and display 10 are also included in the figure. The lens system of FIG. 2A is illustrated in an orientation consistent with that of projector 1 in FIG. 1. Imaging lens arrangement 2 includes first lens L1 located nearest to display 10 as compared to all the other lenses, to serve as the entrance side of the imaging lens arrangement, followed by second lens L2, third lens L3, and fourth lens L4 each of which lenses is arranged progressively further from the display with the fourth lens serving as the exit side of the imaging lens arrangement. All four of the lenses are arranged on an opposite side of the beamsplitter with respect to the display without imposing any lens and/or field lens between the display and the beamsplitter cube. The first lens can be a biconvex lens which defines a first lens surface S1 that can be a convex surface facing towards display 10, and a second; opposing lens surface S2 that can be a concave surface facing away from the display. In one embodiment, the second lens can be a meniscus lens which defines a third lens surface S3 that can be a convex surface facing towards the first lens, and a fourth lens surface S4 that can be a slightly concave surface facing away from the first lens. In another embodiment, the second lens can be plano-convex lens for which the fourth surface may be an at least approximately planar surface facing away from the display. In yet another embodiment, the second lens can be a biconvex lens for which the fourth surface may be a slightly convex surface facing away from the display. The third lens can be a bi-concave lens which defines a fifth lens surface S5 that can be a concave surface facing towards the second lens, and a sixth lens surface S6 that can be a concave surface and facing away from the second lens, and the fourth lens can be a meniscus lens which defines a seventh lens surface S7 that can be a concave surface facing towards the third lens, and an eighth lens surface S8 that can be a convex surface facing away from the third lens. The first, third and fourth lenses may be composed of clear optical plastic, and the second lens may be composed of clear optical glass. The optical material composition of each lens, in this embodiment, can be characterized at least in part by an index of refraction and an Abbe number, with the index of refraction of the first lens of at least approximately 1.53, and the Abbe number of the first lens being at least approximately 56.04; the index of refraction of the second lens of at least approximately 1.74 with an Abbe number of at least approximately 52.68; the index of refraction of the third lens of at least approximately 1.59 with an Abbe number of approximately 29.91, and the index of refraction of the fourth lens can be at least approximately 1.59 with an Abbe number of at least approximately 29.91. It should be appreciated that the foregoing index values and Abbe numbers are not intended as being limiting, and may vary ways that are fully consistent with the scope of this overall disclosure. By way of non-limiting example, the index of refraction of the first lens may have a value from 1.48 to 1.60; the index of refraction of the second lens may have a value from 1.66 to 1.85; the index of refraction of the third lens may have a value from 1.50 to 1.65, and the index of refraction of the fourth lens may have a value from 1.50 to 1.65. Also by way of non-limiting example, the Abbe value of the first lens may have a value from 45 to 66; the Abbe value of the second lens may have a value from 40 to 64; the Abbe value of the third lens may have a value from 21 to 35, and the Abbe value of the fourth lens may have a value from 22 to 34.

It is noted that first lens L1, can be configured with a clear aperture size of 10.0 mm, greater than the clear apertures associated with all of the other lenses, with clear aperture height 36 of L1 extending at least generally orthogonal to the plane of the figure. As described above, the clear aperture height of one or more lenses may be truncated with respect to the clear aperture size of that lens. In one embodiment a clear aperture height 36 of lens L1 may be truncated to a value of approximately 6.2 mm. It is noted that here and throughout the remainder of the disclosure and the appended claims, the term “height” is to be considered as referring to a direction and/or orientation that is at least approximately aligned with height 34 indicated in FIG. 2A. As described previously, the clear apertures of the lenses, at least for each one of a subset of the lenses, forms at least a portion of the aperture arrangement and may confine the image, as it propagates through the lens arrangement, sufficiently to improve MTF as compared to a lens arrangement that does rot incorporate the aperture arrangement.

A radius of curvature can be at least approximately assigned to each surface in accordance with table 1. With respect to the embodiment at hand, it is noted that the first, third and fourth lenses are aspherical lenses, with S1, S2, S5, S6, S7 and S8 being even aspherical surfaces. As the name “aspherical” clearly designates, based on well established terminology, aspherical lens surfaces explicitly deviate from traditional spherical lens surfaces. It should be understood by a person of ordinary skill in the art that the associated radii listed in table 1, can be readily interpreted in the somewhat general sense relating to an overall lens approximate performance, and has been provided for purposes of enhancing the initial understanding of the reader. A complete specification of each even aspherical lens surface, however, is provided immediately hereinafter. It is noted that the second lens in this embodiment is a spherical lens, such that the table entries for surfaces S3 and S4 can be regarded as fully specifying these lens surfaces, at least to an approximation consistent with the number of decimal places associated with each entry.

TABLE 1

| Surface | RADIUS R (in mm) |
|---|---|
| S1 | 17.855 |
| S2 | 6.017 |
| S3 | 5.261 |
| S4 | 4364.759 |
| S5 | 6.438 |
| S6 | 5.133 |
| S7 | 8.436 |
| S8 | 7.181 |

Based on well known conventions, each one of even aspherical surfaces S1, S2, S5, S6, S7 and S8 can be completely specified, at least to an approximation, based on equation 1, in which r represents a distance from the optical axis on which each surface profile is assumed to be centered. The apex of each aspherical surface is assumed to intersect the optical axis, and for each value of r throughout the lens surface, Z sag can be interpreted, in accordance with well known optics conventions, as the distance along the optical axis from the apex.

$$Z sag = \frac{{cr}^{2}}{1 + \sqrt{1 - ( k + 1 ) {c}^{2} {r}^{2}}} + {A}_{4} {r}^{4} + {A}_{6} {r}^{6} + {A}_{8} {r}^{8} + {A}_{10} {r}^{10} + {A}_{12} {r}^{12} \qquad ( Eq . 1 )$$

For surfaces S1, S2, S5, S6, S7 and S8, the values of k, A₄, A₆, A₈, A₁₀ and A₁₂ can be designated, at least to an approximation, in accordance with table 2. The value of c is defined as the inverse of the approximate lens radius according to the equation c=R⁻¹ with R being the radius of each lens surface as specified in TABLE 1.

TABLE 2

| Surface # | K | A₄ | A₆ | A₈ | A₁₀ | A₁₂ |
|---|---|---|---|---|---|---|
| S1 | 3.168 | 1.042E−3 | −5.708E−6 | 5.146E−8 | −4.352E−8 | 7.556E−10 |
| S2 | −0.572 | −2.831E−4 | 1.579E−5 | −1.018E−6 | 2.863E−8 | −7.13E−10 |
| S5 | −17.085 | −1.869E−3 | 5.903E−5 | 1.5333E−6 | −1.505E−7 | 2.852E−9 |
| S6 | 1.837 | −1.066E−2 | 1.405E−3 | −2.139E−4 | −1.655E−6 | 1.577E−6 |
| S7 | 1.459 | 2.579E−4 | 1.080E−5 | −1.940E−6 | 9.117E−8 | −2.974E−9 |
| S8 | −1.115 | 6.781E−4 | 2.282E−5 | −7.723E−7 | 3.061E−8 | −1.797E−10 |

Considering FIG. 2A with reference to FIG. 1, the beamsplitter may be a polarizing beamsplitter cube 24 formed of two right angle prisms, including a first prism 38 and a second prism 40, facing one another to form an interface 42 therebetween. In the embodiment at hand, beamsplitter cube 24 has a length 44, along the optical axis, as indicated in the figure using a double-headed arrow, of 8 mm. In selected embodiments, both of the prisms may have the same index of refraction having a value n. In one embodiment, each of the prisms may have an index of refraction n having a value of at least approximately 1.85. In another embodiment the index n of the prisms may be at least approximately 1.51. Interface 42 may be a polarizing reflector such as a polarizing coating or a polymeric polarizing film. It is noted that the beamsplitter may exhibit an equivalent path length that is different from length 44. Based on well known principles of optics, the equivalent path length of the beamsplitter may be at least approximately equal to cube length 44 divided by the index of refraction n of the prisms. As described previously with reference to FIG. 1, beamsplitter interface 42 may be arranged such that a majority of uniform light 20 is redirected towards the display. Furthermore, a majority of object image 8 may be appropriately polarized to pass straight through the beamsplitter for reception by imaging lens arrangement 2. While the beamsplitter cube of these embodiments does not include any curved lens surfaces integral thereto, at least some aspects of lens-like performance, such as index and dispersion, can be expected to cause the beamsplitter cube to influence overall performance characteristics of the projected image to a degree that is not to be regarded as insignificant, and the lenses of this embodiment can be configured to cooperate with one another and with the beamsplitter cube to account for this influence so as to achieve high performance imaging characteristics, at least selected ones of which are described in detail hereinafter.

As one characteristic of disclosed embodiments, imaging lens arrangement 2 may be configured to exhibit a back focal length 46, as a distance between the display and the first lens surface, that is at least as long as an equivalent path length defined by the beamsplitter cube (FIG. 2A). As described previously, the beamsplitter cube can be arranged for cooperation with the homogenizer arrangement and the light source arrangement to provide for illumination of the display with light having sufficiently high brightness and uniformity to provide for high performance based at least on the condition set forth previously. Therefore, imaging lens arrangement 2 can be customized based on a given beamsplitter cube. Moreover, satisfying this condition with respect to back focal length, while maintaining lens height as not exceeding 2.4 times the display height, is considered by Applicants as a significant recognition in producing an ultra compact and high performance projector system, especially in view of an embodiment that uses less than four lenses.

As another characteristic of the disclosed embodiments, the imaging lens arrangement may exhibit an effective focal length having a value f. Based on well known conventions of imaging optics, the effective focal length may be regarded as a distance between an infinitely thin plane (not shown), representative of an idealized model of the imaging lens arrangement, and the focal point (not shown) of that arrangement. In accordance with well established conventions, it should be appreciated that the back focal length is not the same as an effective focal length defined by the imaging lens arrangement. Furthermore, lenses L1, L2, L3 and L4 may exhibit focal lengths f₁, f₂, f₃ and f₄, respectively. A person of ordinary skill in the art may readily determine these focal lengths based on the descriptions at hand. It should be appreciated that the lens configurations described are in no way intended to be limiting, and that various lens configurations, having different focal lengths, may be accommodated in ways that are fully consistent with the scope of this overall disclosure. For example, the lenses may be configured such that f₁ satisfies the relationship 0.8f<f₁<1.4 f, f₂ satisfies the relationship 0.6 f<f₂<1.2 f, f₃ satisfies the relationship 0.2 f<−f₃<0.8 f, and f₄ satisfies the relationship 2.0 f<f₄<15.0 f.

Attention is now directed to FIG. 2B, which is a diagrammatic view, in elevation, showing one embodiment of display 10. In the illustrated embodiment, and by way of non-limiting example, display 10 may be a high performance microdisplay presently available through Micron Technology Inc., as model number MT7PQHBCBBA-A1, which is a grey scale ferroelectric liquid crystal on silicon (FLCOS) pixel array having a display height 50 of approximately 2.97 mm and,a display width 52 of approximately 5.28 mm as shown in FIG. 2B using double-headed arrows. This embodiment is pixelated, having approximately 518,400 pixels. In one embodiment, the pixels can be arranged in a side by side rectangular array of 960 pixels by 540 pixels, based on part the qHD standard, each having a pixel size 54 of at least approximately 5.5 microns. Each one of the pixels may defines a center point 55 thereof, and the pixels may be arranged in side by side relationships with'one another such that the display defines a pixel pitch 56 as a distance between the center points of any two adjacent ones of the pixels. It can be appreciated that for the case of the qHD embodiment, the pixel pitch may have a value of approximately height divided by 540. Due to illustrative constraints, FIG. 2B shows only a limited number of pixels with several pixels designated by reference number 57. It is noted that the display may be supported by a display substrate 58, and that the substrate may be larger than display 10. However, as will be described in detail hereinafter, the lenses in this embodiment can be limited in size such that for each of the lenses, a clear aperture size of each lens may be less than 10.0 mm. Moreover, as described above, one or more of the lenses may be truncated with respect to height such that the clear aperture height of that lens is reduced as compared to its clear aperture size. In one embodiment, at least for purposes of compactness with respect to height, one or more of the lenses may be truncated with respect to height such that the clear aperture height for each lens is less than 2.4 times the display height of display 10. At least in view of the challenges associated with achieving a low overall height profile, for an embodiment of the imaging lens arrangement as well as the projector system as a whole, ,a package height 60 of the display substrate can be limited to less than 7.2 mm. The display substrate may further serve as a support structure for various electronics circuits (not shown) associated with control and operation of the display, including control logic, power management circuitry, display timing control and a video processor engine. One or more of these electronic circuits may be configured to receive electronic signal 12 (FIG. 1). As will be described hereinafter, the display may be configured to cooperate with the light source arrangement to provide the projected color image in a way that is based at least in part on dynamic sequential display technology.

It should be appreciated that display dimensions (2.97 mm height by 5.28 width), as well as the corresponding lens, aperture sizes and dimensions have been selected for descriptive purposes and are not intended as being limiting. In this regard, various sizes, lens spacings, and dimensions may be accommodated in ways that are fully consistent with the scope of this overall disclosure. For example, as will be described in greater detail hereinafter, a person of ordinary skill in the art, having this disclosure in hand, may readily scale the imaging lens arrangement to provide high quality images emitted at least from any one of many different displays including a display having a larger display size. That is, the concepts that have been brought to light herein can be readily applied at least to larger scale arrangements, and performance characteristics associated with larger, scaled up embodiments can generally be expected to meet or exceed the characteristics associated with embodiments disclosed herein. Likewise, the teachings can be applied with respect to downward scaling and may serve as a basis of further advancement at smaller scale. In one embodiment, the display may be configured as a 720 p display with the pixels arranged in a rectangular 720 pixel by 1080 pixel array with 720 pixels along the height of the display, and 1080 pixels along the width of the display, and this display may exhibit a pixel pitch having a value that is at least approximately H divided by 720. In various embodiments, including but not limited to qHD and 720 p embodiments, the arrangement may be readily scaled to accommodate a display having a pixel pitch greater than 4 um.

With reference to FIG. 2A, it is noted that display 10 of the disclosed display embodiment may be overlaid with a thin optical glass cover 62 in layered contact therewith, having a cover thickness of at least approximately 0.7 mm and an index of refraction of at least approximately 1.52 with an Abbe number of 64. The display may be positioned so that cover 62 is located along the optical axis with a spacing 64, between the input surface of the beamsplitter cube and the cover, of approximately 0.847 mm. It is noted, as is the case with regard to the Micron model MT7PQHBCBBA-A1 display, that the glass cover may be an integral part of the display, provided at least in part for sealing and protecting the display. As is the case with the beamsplitter cube, the glass cover of the present embodiment need not include any curved lens surfaces integral thereto, yet certain aspects of lens-like performance, such as dispersion and/or diffraction may nevertheless cause the glass cover to influence overall performance characteristics of the projected image. Accordingly, the lenses of the embodiment at hand can be configured to cooperate with one another, and with the glass cover, accounting for this influence in order to achieve high performance imaging characteristics that are described in detail hereinafter.

Having provided detailed descriptions of each of the four lenses of this embodiment, with further descriptions relating at least to optical and/or imaging properties of the beamsplitter cube and the display, attention is again directed to FIG. 2A, which uses a series of double-headed arrows to indicate spacing between each lens. In the embodiment at hand, a spacing 66, between the beamsplitter cube and first lens surface S1, is approximately 0.7 mm; a spacing 68, between second lens surface S2 and third lens surface S3, is approximately 0.2 mm; A spacing 70, between fourth lens surface S4 and fifth lens surface S5, is approximately 0.45 mm, and a spacing 72 between sixth lens surface S6 and seventh lens surface S7, is approximately 6.172 mm. It should be appreciated that these spacings are not intended as being limiting, and may vary ways that are fully consistent with the scope of this overall disclosure. For example, spacing 66 may vary from 0.3 mm to 7 mm; spacing 68 may vary from 0.1 mm to 3 mm, spacing 70 may vary from 0.15 mm to 2 mm, and spacing 72 may vary from 1.5 to 15 mm.

The imaging lens arrangement further includes aperture-stop Fl having a diameter D as indicated in FIG. 2A. Furthermore, as described above, the clear aperture heights of the lenses may cooperate with one another to define an aperture arrangement that confines passage of the input image, as the input image propagates through the lens arrangement, to a series of aperture windows each having an aperture size and shape that can be characterized in part by an aperture height. As will be described in greater detail at appropriate points hereinafter, the MTF of the output image, projected through the plurality of lenses, may be higher as compared to a different MTF that would be exhibited without the aperture arrangement. In this embodiment, aperture-stop Fl is disposed between lenses L3 and L4, spaced by an aperture spacing 73 of at least approximately 1.134 mm along the optical axis from lens surface S6 and defines a circular aperture opening, centered on the optical axis and having a diameter of approximately 3.86 mm. As described previously with respect to lenses, the aperture-stop may have an aperture size (for example diameter) and may be truncated such that the aperture-stop exhibits an aperture height that is reduced as compared to the apertur diameter.

Again considering FIG. 1, in conjunction with FIG. 2A, the embodiment of imaging lens arrangement 2 may be supported for motion 63, as indicated in FIG. 1 using a double-headed arrow, such that the imaging lens assembly is movable within a range of lens positions along the optical axis to provide an adjustable focus of the projected image for varying the image distance, within a corresponding range of image distances. It is noted that while the throw ratio associated with the present embodiment is approximately 1.5:1, a person of ordinary skill in the art, having this disclosure in hand, could readily modify the embodiments to provide for throw ratios between 0.8:1 and 2:1. These throw ratios allow the projected image to be focused such that the image plane may be located within in a range of image distances between 150 mm and 2200 mm to produce images having a corresponding range of diagonal image sizes between 5″ and 60″, respectively.

Having disclosed details of an embodiment of an imaging lens arrangement, suitable for use as part of a high performance projection system, selected characteristics of this embodiment, such as f-number, MTF, total distortion and relative illumination will now be described.

As described previously, for the projector to project predetermined large size images, while at the same time providing a predetermined high brightness, even in the case of an embodiment that utilizes a state of the art high brightness light source arrangement, it may be of benefit for the lens system to exhibit an f-number sufficiently low such that the lens system does not excessively limit the amount of light available from the light source arrangement. In the context of ultra compact high performance projectors, Applicants recognize that it may be desirable for the imaging lens arrangement to exhibit an f-number of no more than 1.7. In this regard, it is noted the embodiment at hand exhibits an f-number of at least approximately 1.5.

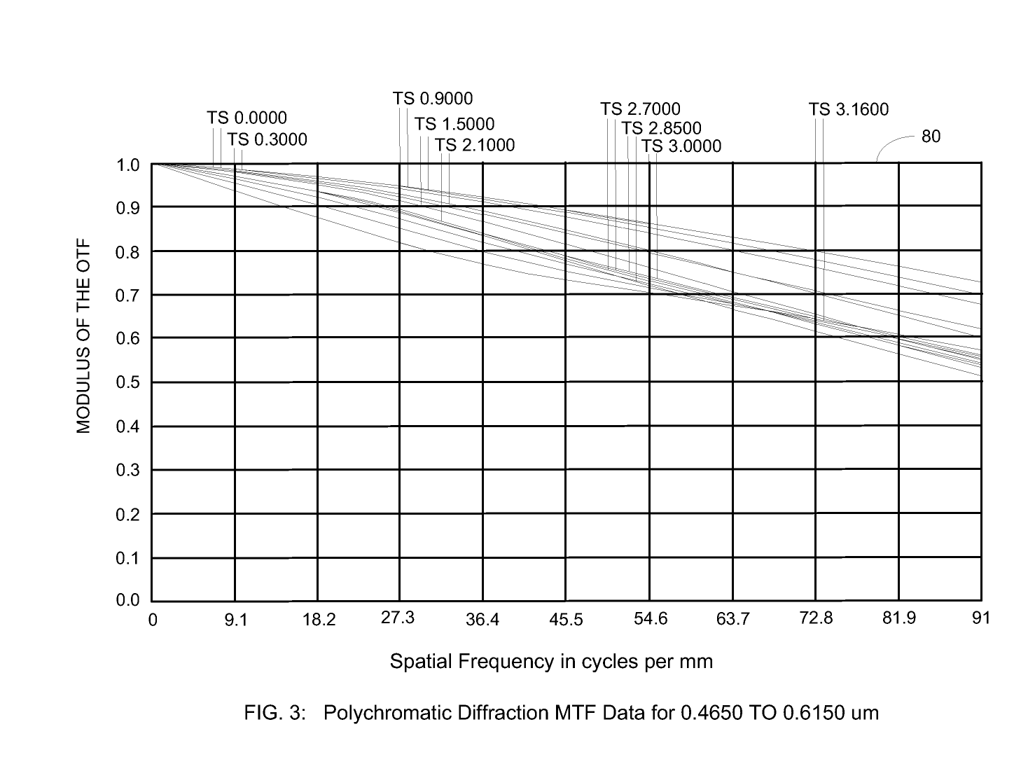

Attention is now turned to FIG. 3, which is a graph, generally indicated by the reference number 80 plotting MTF over a range of values of spatial frequency. Graph 80 includes a horizontal axis oriented horizontally and representing spatial frequency in cycles per mm, and a vertical axis representing polychromatic diffraction MTF. It is noted that for purposes of descriptive brevity, polychromatic MTF may hereinafter be referred to as MTF. In the context of imaging lens arrangement 2, based on well established conventions, each value of spatial frequency represents a spatial frequency of one or more features associated with the input object image emitted from the display, while the plotted values of MTF can be characterized with respect to the projected color image. It is noted that the MTF values plotted in graph 80, can be generated using one or more of a number of commercially available ray tracing software applications that are commonly utilized for characterizing designs of imaging optical systems.

Graph 80 includes twenty plots of MTF, each of which is labeled, based on well established conventions, as corresponding to a given field of view from the center of a display. Furthermore, each plot is labeled with a “T” or an “S” indicated that the plot is associated with the tangential or sagittal plane of the imaging lens arrangement. For reference purposes, each plot may be referred to according to the foregoing designations. Based on well established conventions, a given value of spatial frequency can be at least generally ascribed to a given feature size associated with part of an object image. In general, as will be appreciated by a person of ordinary skill in the art, higher values of spatial frequency correspond to smaller feature sizes. For example, in the case where the given feature is a pixel having a given pixel size, then the smaller the pixel size, the higher the spatial frequency associated therewith. Similarly, based well established conventions, the spatial frequency may be referred to in relation to the pixel pitch of a given display. The spatial frequency associated with the pixel size and/or pixel pitch, for a given display, may be considered as particularly significant, since the pixel size constitutes the smallest feature detail produceable by that display.

It is noted that the plots of graph 80 may be considered as accounting for color influence within a visible spectrum range with using a light source arrangement including at least one blue source centered at approximately 465 nm wavelength; at least one green source centered at approximately 525 nm; and at least one red source centered at approximately 615 nm wavelength. The weighting factors for the foregoing RGB light source arrangement may be 1:3:1 respectively. Thus, plots of graph 80 can be regarded as displaying polychromatic MTF for color images, in accordance with the foregoing wavelength weighting.

For an embodiment with pixels each having pixel size of 5.5 microns, the corresponding spatial frequency associated with the display is approximately 91 cycles per millimeter. Graph 80 indicates that imaging lens arrangement 2 can be characterized as having polychromatic MTF values computed as being greater than 50% at this, spatial frequency, and for any spatial frequencies below this value. This computed performance is considered as exceeding MTF requirements associated with high performance projection as described previously. (As described above, the MTF values plotted in graph 80 can be generated using one or more of a number of commercially available ray tracing software applications, such as Zemax®.) It is further noted that the computed characterization of MTF greater than 50% is based in part on computer modeling of lens positioning with the idealized assumption, for modeling purposes, of a high degree of lens mounting precision. While measured MTF consistent with that of plot 80 is attainable at least in laboratory and/or prototype measurements, by employing state of the art positioning techniques. Applicants recognize that it may be prohibitively costly and/or impractical, at least based on currently available high volume and low cost manufacturing techniques, to consistently produce the disclosed imaging lens arrangement with sufficient lens mounting precision for achieving measurable MTF>50%. However, as described above, MTF>30% is believed by Applicants to exceed reasonable criterion for high performance projection, such that some amount of diminished performance in this regard is to be considered acceptable. Current manufacturing facilities and techniques, while providing for somewhat diminished measured MTF performance, are suitable to provide for measurable MTF>30%, throughout the range of spatial frequencies represented in FIG. 3 including at the-spatial frequency of 91 cycles per millimeter corresponding to 5.5 micron pixels of disclosed embodiments.

The aperture arrangement, defined in part by clear apertures of the lenses, and in part by aperture-stop indicated in FIG. 2A as F1, may be configured to confine passage of the input image, as the input image propagates through the plurality of lenses, to within one or more aperture windows each window having a size and shape that is characterized in part by a height that is less than the projector height. It is noted that graph 80 is representative of MTF of disclosed embodiments only insofar as each embodiment includes the aperture arrangement, and that the MTF as plotted may be higher, at least for a range of spatial frequencies, as compared to a different MTF for a different embodiment that does not include the aperture arrangement. As described previously, the aperture arrangement, while increasing MTF, may cause limited decrease in brightness, to a limited degree that may be considered as acceptable, at least for portions of any image projected by the imaging lens arrangement. With respect to such embodiments, Applicants believe that excellent overall projector performance can nevertheless be provided in view of the overall teachings herein. It is noted that the described use of the aperture arrangement, at least in the context of trading MTF against projector height, is not to be considered in any way as limiting, and a designer may choose to provide a different aperture arrangement, including different clear aperture heights for one or more of the lenses, and/or including a different aperture-stop at a different position along the optical axis, or may otherwise configure the aperture arrangement according to numerous variations that will be apparent to any person of ordinary skill in the art.

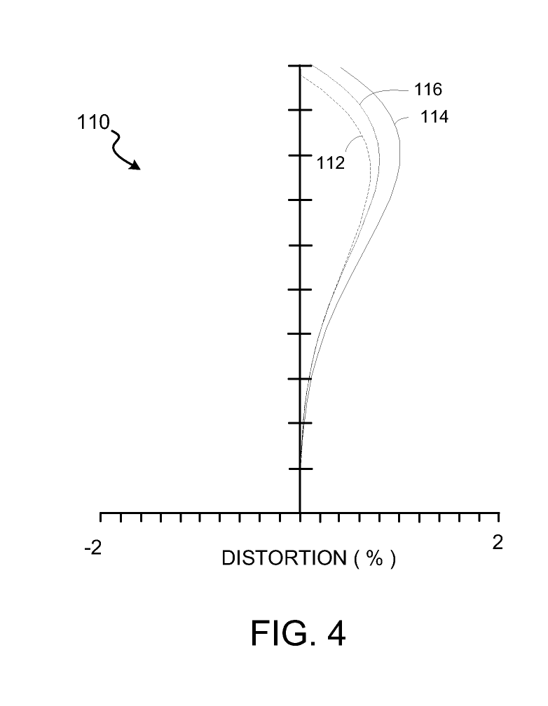

Attention is now directed to FIG. 4, which is a graph, generally indicated by the reference number 110, that plots image distortion associated with various positions on display 10 (FIG. 2). Based on well known modeling and measurement techniques, and in accordance with well established conventions for characterizing projection systems, image distortion of a projected image can be characterized with respect to projected images associated with different portions of display 10. Graph 110, generated using ray tracing software includes a vertical axis representing a range of display positions, and a horizontal axis corresponding to percentage distortion. Graph 110 includes plots 112, 114, and 116 corresponding to colors blue, green and blue, respectively. Plots 112, 114, and 116 indicate that imaging lens arrangement 2 can be characterized as exhibiting a total distortion less than of 1.0%, which is considered as being fully consistent with high performance projection as described previously.

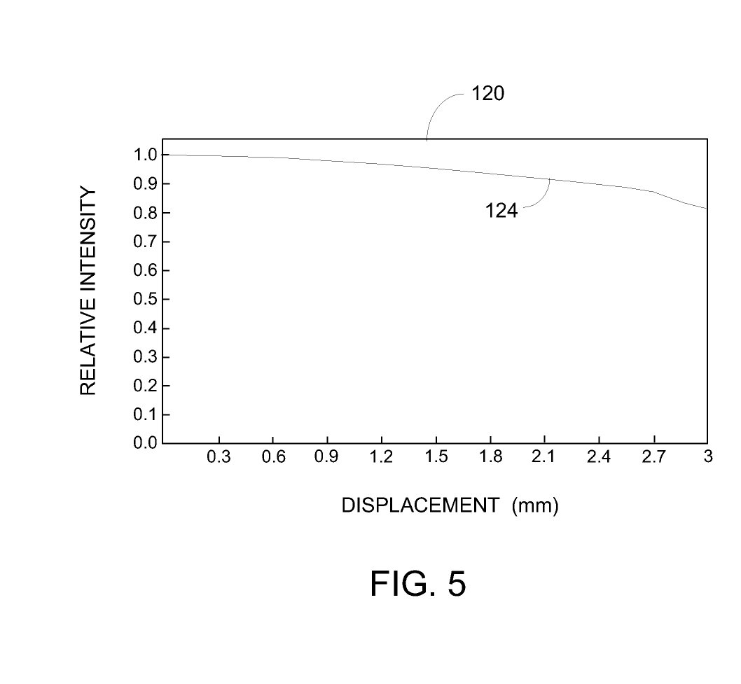

Attention is now turned to FIG. 5, in conjunction with FIG. 1, which is a graph 120 plotting relative illumination associated with various positions on the display. In accordance with well established conventions, relative illumination can be characterized, for a particular projected image that can be generated responsive to a uniform object image having approximately uniform intensity. In this case, the particular projected image may exhibit an intensity distribution, as intensity variation related to a reference value of intensity at centrally located reference portion 122 of the projected image, indicated in FIG. 1. The uniform intensity may be generated based on an electrical signal 12, provided as a test signal, that causes each pixel of the display to emit light of the same intensity as all other pixels. Graph 120 includes a plot 124, produced using Zemax®, based in part on a set of input data representative of a uniform object image corresponding to uniform white light, and further includes a horizontal axis corresponding to various display positions, distributed across the diagonal of the display centered with respect to the center of the display, and a vertical axis showing relative percentage of intensity variation. It is noted that the intensity drops off somewhat for locations that are progressively further from the central reference portion of the projected image, such that an outer peripheral region of the projected image is slightly dimmer as compared to that of the central region. In terms of art, this effect is generally referred to as vignetting, and while a small and/or acceptable degree of vignetting has been introduced in order to provide for higher MTF and smaller component size, higher levels of vignetting can cause images to develop a noticeable tunnel-like appearance generally considered unacceptable except in cases when it may be intentionally introduced for artistic purposes and/or for use as an easily noticeable special effect. Any person who has examined nineteenth century photographs, such as portraits of legendary characters in stories of the American West, may be familiar with easily noticeable vignetting often present due to relatively low imaging performance of the early photographic apparatus and techniques. It is noted that vignetting, noticeable or otherwise, can be increased with a decrease in aperture size and/or height, and can be mitigated with an increase in aperture size and/or height. In the case of imaging lens arrangement 2, a decrease in diameter and height of L1, L2, L3 and L4 may tend to increase vignetting such that relative illumination may tend to exhibit a greater degree of variation as compared to the disclosed embodiment, while an increase in these diameters and height may tend to decrease vignetting such that relative illumination may tend to exhibit a lesser degree of variation. As described above, Applicants recognize that variation in clear aperture size and/or height influences a number of performance and projector dimension tradeoffs, with smaller aperture size and/or height influencing MTF and projector height in a beneficial way, while imposing a design tradeoff that includes some extent of performance compromise with respect to brightness and vignetting. In this case, a certain degree of degradation with respect to vignetting can be acceptable for a predetermined improvement with respect to MTF and projector height.

Applicants believe that the performance characteristics, associated with disclosed embodiments of imaging lens arrangement 2, implement a “high performance” projector system that can be characterized at least by (i) MTF greater than 30% for all spatial frequencies at and below the frequency associated with the display pixel pitch, (ii) total distortion of less than 1.0%, and (ii) variation in intensity of less than 20%. Moreover, embodiments of imaging lens arrangement 2 can exhibit such high performance in conjunction with low height profile having lens heights less than 2.4 times the display height, while providing a relatively long back focal length, sufficient for accommodating a beamsplitter cube. Furthermore, these attributes have been implemented in a lens configuration that can use no more than four lenses in order to insure that the imaging lens arrangement exhibits a reduced cost and a reduced overall length 130 (FIG. 2A) at least as compared to conventional configurations having more than four lenses.

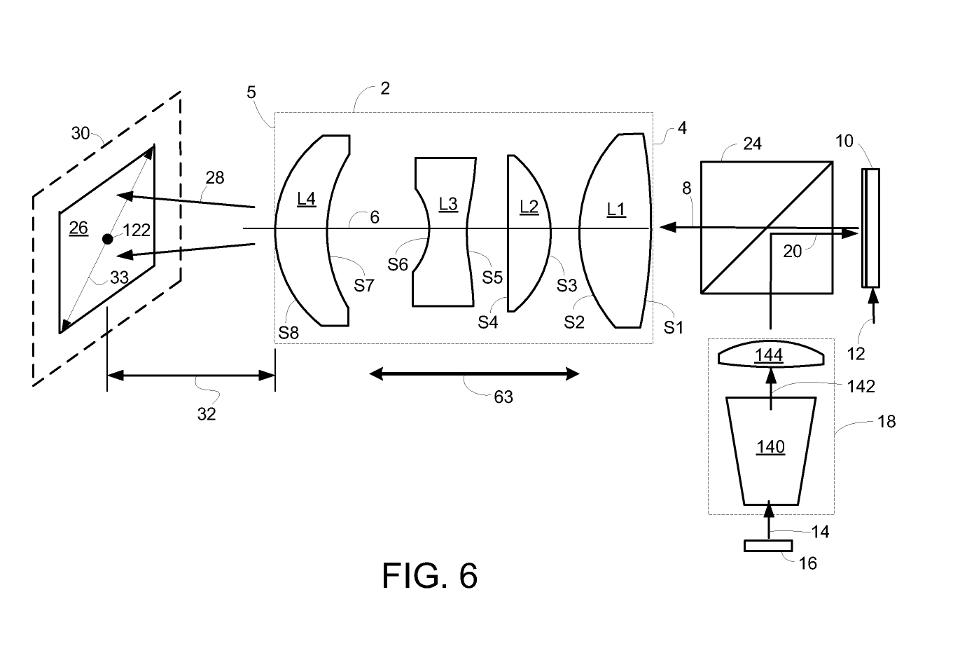

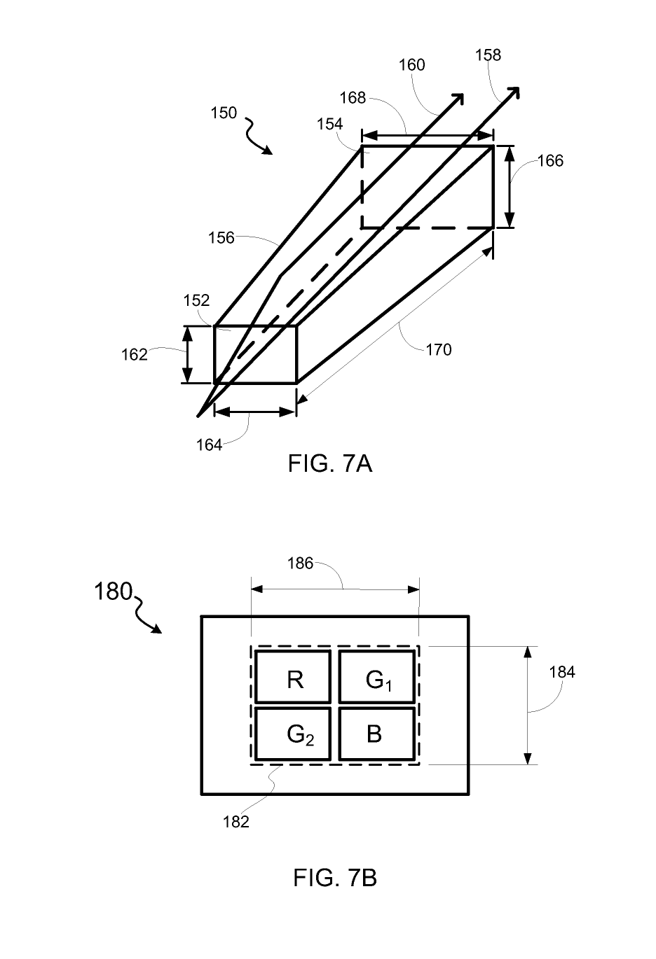

Attention is now turned to FIG. 6, with ongoing reference to FIG. 1. FIG. 6 is a diagrammatic view, in elevation, which illustrates further details with respect to the ultra compact high performance embodiment of projector system 1. Projector system 1, as described with respect to FIG. 1, includes homogenizer arrangement 18 configured to receive initial non-uniform light 14 from light source arrangement 16, and to spatially homogenize this non-uniform light to produce uniform light 20 such that at least a majority thereof can be focused onto display 10. It is noted that homogenizer arrangement 18 is indicated in FIG. 6 as within a dashed box. The initial non-uniform light may exhibit spatial intensity variations such that in the absence of any homogenizer arrangement, focusing of this initial light onto display 10 would tend to illuminate the display in a non uniform pattern of illumination that can cause an unacceptable degree of non uniformity, in the projected image, that may be unsuitable for projection of high quality images. Applicants have arranged a light pipe 140 which receives initial light 14 and produces therefrom homogenized light 142 having, substantially greater intensity uniformity as compared with initial light 14. Light pipe 140 may be followed by a relay lens arrangement 144 configured to focus homogenized light 142 to produce uniform light 20 such that this uniform light can be focused to a sufficient degree that at least a majority thereof is directed onto display 10. Applicants have designed, produced, and tested a number of light pipe configurations that provide for sufficient spatial homogenization for high performance projection as described in the present disclosure. Having now set forth further detail with respect to high performance projector system 1, one embodiment will be disclosed immediately hereinafter, with various features illustrated in FIGS. 7A and 7B.

Attention is now drawn to FIG. 7A, with ongoing reference, to FIG. 6. FIG. 7A is a diagrammatic view, in perspective, of a low profile light pipe generally indicated by reference number 150, configured to serve as light pipe 140 of FIG. 6. Light pipe 150 is configured to at least exhibit sufficiently low height profile for use in embodiments of ultra compact high performance projector system 1. Light pipe 150 defines an input end 152 and an output end 154 and tubular surface 156 extending therebetween. (It is noted that light pipes may, in accordance with well known terms of art, at times be referred to as “integration rods” and/or “light tunnels”.) Tubular surface 156 at least generally defines a closed shape in cross-section at any given location along the pipe, and the cross section may have any suitable shape including but not limited to square, rectangular, or polygonal. With respect to embodiments disclosed herein, the tubular surface may have a rectangular cross section as illustrated in FIG. 7A. The input end of the illustrated embodiment is rectangular and can be aligned for receiving at least a majority of initial light 14 produced by light source arrangement 16. Based on well known principles of operation associated with light pipes, a first portion of initial light 14 may propagate directly through light pipe 150 to exit through output surface 154 without impinging upon any portion of the tubular surface, while a second portion of initial light 14 may be reflected by the tubular sidewall to propagate reflectively through the light pipe such that the first and second portions of light mix with one another to produce output light that exhibits a lower degree of spatial variation as compared to initial light 14. A person of ordinary skill in the art, familiar with conventional light pipes and the principles of operation thereof, will appreciate that the second portion of light can propagate in complex combinations of multiple paths, with multiple reflections distributed throughout tubular surface 156. However, for purposes of illustrative clarity, the first and second light portions are schematically indicated in FIG. 7A using two rays indicated by reference numbers 158 and 160, respectively. First portion 158 of initial light 14 is indicated using a straight arrow intended as being illustrative of direct propagation through the light pipe, while reflected portion 160 of initial light 14 is indicated using a bent ray intended as being illustrative of reflections caused by incidence thereof with surface 156 of light pipe 150.

In an embodiment, input surface 152 of light pipe 150 may, for example, have a height 162 of approximately 1.1 mm and a width 164 of approximately 1.7 mm, and output surface, defining a larger rectangle than the input surface. The output surface may have a height 166 of at approximately 1.2 mm and a width 168 of approximately 2.14 mm. As illustrated in the figure, the output surface of this embodiment can be axially aligned with and at least approximately parallel to the input surface, having a length 170 therebetween of approximately 7.5 mm. The light pipe may be composed of optical glass and/or plastic having an index of refraction of approximately 1.5 and Abbe number of approximately 58. It is noted that the height and width of the output surface of light pipe 150 are less than the height and width of display 10 as described with respect to the embodiment of FIG. 2B, such that the light pipe exhibits a height profile that can be lower than that of the imaging lens arrangement.

In one embodiment light pipe 150 may be followed by relay lens arrangement 144 configured for imaging the end of the light pipe onto the display.

Attention is now directed to FIG. 7B which illustrates a diagrammatic plan view of one state-of-the-art light source arrangement 16 produced and distributed by Micron Technology, Inc. This light source arrangement, includes an array of four high intensity light emitting diodes (LED'S), including red, green, green and blue sources indicated in FIG. 7B as R, G₁, G₂, and B, respectively. These LED's may be supported in side by side relationships with one another to define a light source surface 182, represented in the figure using a dashed box, having a height 184 of approximately 1 mm, and a width 186, from approximately 1.0 mm to approximately 1.6 mm, aligned such that each of the LED's projects light in one common direction that is at least generally orthogonal to surface 182.

Surface 182 of light source arrangement 180 may be aligned, as illustrated in FIG. 6, such that light pipe 150 receives at least a majority of any light produced by all of the four LED's. The described embodiments may be operated based, at least in part, on dynamic updating of field sequential displays with the FLCOS panel and the light source arrangement configured to cooperate with one another at least generally in a manner that is known to those familiar with FLCOS displays. The pixel array of the FLCOS panel may be capable of extremely fast switching such that it is ideally suited to the display of real time video. Some embodiments of these displays have been configured for illumination by LEDs, such as those shown in FIG. 7B, however, other suitable light sources can be used without limitation. A field sequential display generally presents video to a viewer by breaking the frames of an incoming video stream into subframes of individual red, green and blue subframes. Only one color subframe is presented to the viewer at a time. That is, the pixels of the pixel array can be illuminated at different times by an appropriate color of light associated with the red, green and blue subframes in a way that produces a grayscale image for each subframe. The color subframes can be presented to the viewer so rapidly, however, that the eye of the viewer integrates the individual color subframes into a full color image. In the instance of an incoming video stream, the processing for purposes of generating the subframes is generally performed in real time while the pixels of the display are likewise driven in real time.

In view of the foregoing, Applicants have brought to light an imaging lens arrangement suitable for use in an ultra compact high performance projection system that incorporates a state-of-the-art high brightness miniature light source and a state-of the art high resolution miniature display. Embodiments of the projection lens arrangement can cooperate at least with these components to provide for high performance projection as set forth above, including providing for high brightness, high MTF, low distortion and a high degree of intensity uniformity.

Furthermore, in conjunction with the disclosed embodiments of imaging lens arrangement 2, the use of a light pipe based homogenizer is believed by Applicants to provide further benefits, heretofore unseen, including low cost and simplified assembly.

As described previously, Applicants consider that design and production of any ultra compact projector system, having sufficiently low profile to fit within the peripheral outline of today's and future handheld devices while providing for high performance, such as high-resolution, introduces a combined set of challenges and design tradeoffs that cannot be reasonably addressed merely by miniaturization based on traditional projector systems and/or traditional imaging lens arrangements. Furthermore, Applicants believe that recognizing and addressing the full scope of these combined challenges and tradeoffs is well beyond the capability of persons of ordinary skill in the art.

The foregoing descriptions are in no way intended as being limiting, and the teachings of the present disclosure can be readily practiced in larger scale devices. For example, the host device could be a stand-alone module and/or a laptop computer, as opposed to a mobile phone that imposes severe height constraints.

In general, regardless of extent of upward scaling, any high performance characteristics including but not limited to MTF>30% and total distortion <1.0%, may remain at least generally unchanged for each of a range of scaled-up embodiments. It is noted that for purposes of descriptive clarity, a number of features associated with the disclosed embodiment have been described by Applicants in a way that is independent of scale and that readily applies to a range of differently scaled embodiments. For example, the requirement that the ratio of lens height to display height does not exceeding 2.4 can remain unchanged for each of a range of scaled up embodiments. As another example, the back focal length of the imaging lens system is characterized as being at least sufficiently long to accommodate a beamsplitter such that the beamsplitter at least fits between the display and the first lens.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. An imaging lens arrangement, for use in an imaging projector system with a display having a display height, of value H, and a display width, of value W, that is greater than the display height, the display including a plurality of pixels each having a pixel size, the imaging lens arrangement comprising:
a plurality of no more than four lenses, defining an optical axis, an entrance side and an exit side, and configured to cooperate with a given beamsplitter for receiving and imaging an object image that emits from the display and passes through the beamsplitter and is received at the entrance side to propagate through the plurality of lenses, at least generally along the optical axis, to produce a projected image from the object image that exits the imaging lens arrangement from the exit side, and each lens has a clear aperture height that is at least generally aligned in the same direction as the display height, and for each of the lenses, the clear aperture height of that lens exceeds the display height by no more than 2.4 times the display height, and the imaging lens arrangement is at least generally object space telecentric, and exhibits a low f-number of no more than 1.7,
wherein the given beamsplitter exhibits an equivalent path length, and the plurality of lenses defines a back focal length that is at least as long as the equivalent path length of the given beamsplitter.

2. The imaging lens arrangement of claim 1 further comprising for any portion of the projected image within the image plane, the imaging lens arrangement is configured such that an image quality at that portion is characterized by an image distortion, and the total distortion associated with any portion of the projected image is less than 1.0%.

3. The imaging lens arrangement of claim 1 further comprising the lenses configured to cooperate with one another to define an image plane at which the projected image is at least approximately focused, which image plane is located at an image distance from the exit side of the lens arrangement,
wherein each one of the pixels defines a center point thereof, and the pixels are arranged in side by side relationships with one another such that the display defines a pixel pitch as a distance between the center points of two adjacent ones of the pixels, and for any portion of the projected image within that image plane, the imaging lens arrangement provides an image quality at that portion that can be characterized at least in part by a value of polychromatic diffraction MTF that is greater than 30% at a spatial frequency corresponding to the pixel pitch of the display.

4. The imaging lens arrangement of claim 3 further comprising a high resolution display serving as the display, having a pixel pitch with a value from at least approximately 4 um to at least approximately 9 um.

5. The imaging lens arrangement of claim 4 further comprising the display configured as a qHD display with the pixels arranged in a rectangular 540 pixel by 960 pixel array with 540 pixels along the height of the display, and 960 pixels along the width of the display, and the display exhibits a pixel pitch having a value that is at least approximately H divided by 540.

6. The imaging lens arrangement of claim 4 further comprising the display configured as a 720 p display with the pixels arranged in a rectangular 720 pixel by 1080 pixel array with 720 pixels along the height of the display, and 1080 pixels along the width of the display, and the display exhibits a pixel pitch having a value that is at least approximately H divided by 720.

7. The imaging lens arrangement of claim 3 wherein a beamsplitter cube serves as the given beamsplitter and includes an equivalent path length that is at least 1.1 times the width of the display, and the imaging lens arrangement further comprising the back focal length of the imaging lens arrangement at least as long as the equivalent path length of the given beamsplitter.

8. The imaging lens arrangement of claim 3 further comprising an aperture arrangement that confines passage of the input image, as the object image propagates through the plurality of lenses, to within one or more aperture windows, such that the MTF of the output image produced by the plurality of lenses, is higher as compared to a different MTF that would be exhibited without the aperture arrangement.

9. The imaging lens arrangement of claim 8 further comprising the aperture arrangement including an aperture-stop arrangement that defines an aperture window having a circular shape.

10. The imaging lens arrangements of claim 9 further comprising the aperture-stop arrangement positioned following a selected one of the plurality of lenses, and the circular shape has a diameter of at least approximately 3.86 mm.

11. The imaging lens arrangement of claim 8 further comprising a configuration of the lenses such that for a uniform input image, at least having approximately uniform intensity, a central portion of the projected image exhibits a reference value of intensity, and the projected image exhibits spatial intensity variation, throughout all lateral positions thereof, of less than 20% of the reference value of intensity.

12. The imaging lens arrangement of claim 3 further comprising at least one of the lenses movable within a range of lens positions along the optical axis to vary the image distance, based at least in part on the lens position, within a corresponding range of image distances, to provide an adjustable focus of the projected image.

13. The imaging system of claim 12 further comprising at least the movable lens configured for movement at least between a first position and a second position, and the plurality of lenses cooperate with one another such that with the movable lens in the first position, the corresponding image plane is located at a first image distance and the projected image focused thereon exhibits a diagonal size less than five inches; and
with the movable lens in the second position, the corresponding image plane is located at a second image distance, longer than the first image distance, and the projected image focused thereon exhibits a diagonal size of more than sixty inches.

14. The imaging lens arrangement of claim 3 further comprising no more than 4 lenses, including a first lens located nearest to the display as compared to all the other lenses to serve as the entrance side of the imaging lens arrangement followed by a second lens, a third lens, and a fourth lens arranged progressively further so that the fourth lens serves as the exit side of the imaging lens arrangement, and all four of the lenses are arranged on an opposite side of the beamsplitter cube with respect to the display without imposing a lens between the display and the beamsplitter cube.

15. The imaging lens arrangement of claim 14 further comprising:
the first lens is a biconvex lens having a positive lens power such that the first lens is characterized at least in part by focal length f₁ that has a positive value,
the second lens is characterized at least in part by a focal length f₂ that has a positive value,
the third lens is a bi-concave lens having a negative lens power such that the third lens is characterized at least in part by a focal length f₃ that has a negative value, and
the fourth lens is a meniscus lens having a positive lens power such that the fourth lens is characterized at least in part by a focal length f₄ that has a positive value.

16. The imaging lens arrangement of claim 15 further comprising the lenses configured to cooperate with one another such that the imaging lens arrangement exhibits an effective focal length having a value f, wherein f₁ satisfies the relationship 0.8 f<f₁<1.4 f, f₂ satisfies the relationship 0.6 f<f₂<1.2 f, f₃ satisfies the relationship 0.2f<−f₃<0.8 f, and f₄ satisfies the, relationship 2.0 f<f₄<15.0 f.

17. The imaging lens arrangement of claim 16 further comprising:
the first lens defines a first lens surface that is a convex surface facing towards the display, and a second, opposing lens surface facing away from the display,
the second lens defines a third lens surface that is a convex surface facing towards the first lens, and a fourth lens surface facing away from the first lens,
the third lens defines a fifth lens surface that is a concave surface facing towards the second lens, and a sixth lens surface that is a concave surface and facing away from the second lens,
the fourth lens defines a seventh lens surface that is a concave surface facing towards the third lens, and an eighth lens surface that is a convex surface facing away from the third lens.

18. An imaging lens arrangement, for use in an imaging projector system having a display that emits an object image, the imaging lens arrangement comprising:
a first lens is a biconvex lens having a positive lens power such that the first lens is characterized at least in part by focal length f₁ that has a positive value,
a second lens is characterized at least in part by a focal length f₂ that has a positive value,
a third lens is a bi-concave lens having a negative lens power such that the third lens is characterized at least in part by a focal length f₃ that has a negative value, and
a fourth lens is a meniscus lens having a positive lens power such that the fourth lens is characterized at least in part by a focal length f₄ that has a positive value,
wherein the lenses are configured to cooperate with one another such that the imaging lens arrangement exhibits an effective focal length having a value f, and f₁ satisfies the relationship 0.8 f<f₁<1.4 f, f₂ satisfies the relationship 0.6 f<f₂<1.2 f, f₃ satisfies the relationship 0.2 f<−f₃<0.8 f, and f₄ satisfies the relationship 2.0 f<f₄<15.0 f.

19. The imaging lens arrangement of claim 18 further comprising:
the first lens defines a first lens surface that is a convex surface facing towards the display, and a second, opposing lens surface that is a convex surface facing away from the display,
the second lens defines a third lens surface that is a convex surface facing towards the first lens, and a fourth lens surface that faces away from the first lens,
the third lens defines a fifth lens surface that is a concave surface facing towards the second lens, and a sixth lens surface that is a concave surface and facing away from the second lens, the fourth lens defines a seventh lens surface that is a concave surface facing towards the third lens, and an eighth lens surface that is a convex surface facing away from the third lens.

20. The imaging lens arrangement of claim 19 wherein the first, third and fourth lenses are all composed of clear optical plastic, and the second lens is composed of clear optical glass.

21. The imaging lens arrangement of claim 20 further comprising an index of refraction of the first lens having a value from 1.48 to 1.60; the index of refraction of the second lens having a value from 1.66 to 1.85; the index of refraction of the third lens having a value from 1.50 to 1.65, and the index of refraction of the fourth lens having a value from 1.50 to 1.65.

22. The imaging lens arrangement of claim 21 wherein the index of refraction of the first lens is at least approximately 1.53; the index of refraction of the second lens is at least approximately 1.74; the index of refraction of the third lens is at least approximately 1.59, and the index of refraction of the fourth lens is at least approximately 1.59.

23. The imaging lens arrangement of claim 21 further comprising an Abbe value of the first lens having a value from 45 to 66; the Abbe value of the second lens having a value from 40 to 64;
the Abbe value of the third lens having a value from 21 to 35, and the Abbe value of the fourth lens having a value from 22 to 34.

24. The imaging lens arrangement of claim 23 wherein the Abbe value of the first lens is at least approximately 56; the Abbe value of the second lens is at least approximately 53; the Abbe value of the third lens is at least approximately 30, and the Abbe value of the fourth lens is at least approximately 30.

25. The imaging lens arrangement of claim 19 further comprising each of the curved surfaces is specified by a radius of curvature, wherein
a radius of curvature of the first surface, at least to an approximation, is 17.855 mm;
a radius of curvature of the second surface, at least to an approximation, is 6.017 mm;
a radius of curvature of the third surface, at least to an approximation, is 5.261 mm;
a radius of curvature of the fifth surface is at least approximately 6.438 mm;
a radius of curvature of the sixth surface is at least approximately 5.133 mm;
a radius of curvature of the seventh surface, at least to an approximation, is 8.436mm;
a radius of curvature of the eighth surface, at least to an approximation, is 7.181 mm,
and each of the lenses can be characterized in part by a lens thickness, as a measure of distance, along the optical axis, of the opposing surfaces at a central location of each lens, wherein
a first lens thickness, of the first lens, is at least approximately 3.9 mm;
a second lens thickness, of the second lens, is at least approximately 2.3 mm;
a third lens thickness, of the third lens, is at least approximately 2.0 mm;
a fourth lens thickness, of the fourth lens, is at least approximately 2.7 mm.

26. The imaging lens arrangement of claim 25 further comprising the fourth lens surface is a selected one of an at least approximately planar surface;
a convex surface having a radius of curvature from 35 mm to 5000 mm, and
a concave surface having a radius of curvature from 80 mm to 6000 mm.

27. The imaging lens arrangement of claim 25 wherein a subset of lens surfaces including the first, second, fifth, sixth, seventh and eighth lens surfaces are even aspherical lens surfaces, each one of which exhibits a sag z that varies with radius r from the optical axis, based on the expression
$$Z sag = \frac{{cr}^{2}}{1 + \sqrt{1 - ( k + 1 ) {c}^{2} {r}^{2}}} + {A}_{4} {r}^{4} + {A}_{6} {r}^{6} + {A}_{8} {r}^{8} + {A}_{10} {r}^{10} + {A}_{12} {r}^{12}$$
wherein for each lens surface of the subset, c=R ⁻¹, R is the radius of curvature for that lens surface, and k is a conic constant for that lens surface, A₄, A₆, A₈, _{A10}, and A₁₂ are aspheric constants for that lens surface, and each surface is configured according to

| Surface # | K | A₄ | A₆ | A₈ | A₁₀ | A₁₂ |
|---|---|---|---|---|---|---|
| S1 | 3.168 | 1.042E−3 | −5.708E−6 | 5.146E−8 | −4.352E−8 | 7.556E−10 |
| S2 | −0.572 | −2.831E−4 | 1.579E−5 | −1.018E−6 | 2.863E−8 | −7.13E−10 |
| S5 | −17.085 | −1.869E−3 | 5.903E−5 | 1.5333E−6 | −1.505E−7 | 2.852E−9 |
| S6 | 1.837 | −1.066E−2 | 1.405E−3 | −2.139E−4 | −1.655E−6 | 1.577E−6 |
| S7 | 1.459 | 2.579E−4 | 1.080E−5 | −1.940E−6 | 9.117E−8 | −2.974E−9 |
| S8 | −1.115 | 6.781E−4 | 2.282E−5 | −7.723E−7 | 3.061E−8 | −1.797E−10 |

28. The imaging lens arrangement of claim 27 further comprising the lenses arranged such that
a distance, along the optical axis, between the second lens surface and the third lens surface, along the optical axis, is at least approximately 0.2 mm;
a distance, along the optical axis, between the fourth lens surface and the fifth lens surface, along the optical axis, is at least approximately 0.45 mm;
a distance, along the optical axis, between the sixth lens surface and the seventh lens surface, along the optical axis, is at least approximately 6.172 mm.

29. The imaging lens arrangement of claim 28 further comprising a beamsplitter cube serving as the beamsplitter and having an equivalent path length that is at least 1.1 times the width of the display, and the back focal length is at least as long as this equivalent path length, and the beamsplitter cube includes an input surface, facing the display, and an opposing output surface, facing the lenses, and the cube is composed of optical glass having an index of refraction in a range from 1.48 to 1.88 and has a cube thickness, between the input and output surfaces, of approximately 8 mm, and the cube is arranged such that a distance, along the optical axis, between the first lens surface and the output surface of the beamsplitter cube is in a range from 0.3mm to 7 mm.

30. A projection system configured for receiving an electrical signal and projecting an image based thereon, the projection system comprising:
a light source arrangement configured to produce initial light that exhibits an intensity distribution that varies in a plane that is at least generally transverse to a given direction of propagation associated therewith;
a light pipe defining an input end, an output end, and a tubular sidewall surface extending therebetween, and the input end is aligned for receiving at least a majority of the initial light produced by the light source, a first portion of which propagates directly through the lightpipe to exit through the output without impinging upon the sidewall, and a second portion of which is reflected by the tubular sidewall to propagate reflectively through the light pipe such that the first and second portions of received light mix with one another to produce output light that exhibits a lower degree of spatial variation as compared to the initial light;
a display having a display height, of value H, and a display width, of value W, that is greater than the display height, the display including a plurality of pixels each having a pixel size;
a beamsplitter that is aligned to receive the output light, from the light mixing tube, and to direct the output light for incidence on the display to illuminate the pixels of the display, and the pixels of the display are configured to receive the electrical signal and to cooperate with one another such that the illumination of the pixels causes the display to emit an object image, for subsequent projection thereof, based on the electrical signal;
an imaging lens arrangement including a plurality of no more than four lenses, defining an optical axis, an entrance side and an exit side, and configured to cooperate with the beamsplitter for receiving and imaging the object image that emits from the display and passes through the beamsplitter and is received at the entrance side to propagate through the plurality of lenses, at least generally along the optical axis, to produce a projected image from the object image that exits the projection lens arrangement from the exit side, and each lens has a clear aperture height that is at least generally aligned in the same direction as the display height, and for each of the lenses, the clear aperture height of that lens is less than 2.4 times the display height, and the imaging lens arrangement is at least generally object space telecentric and exhibits a low f-number of no more than 1.7,
wherein the output end of the light pipe has a light pipe height that is at least generally aligned in the same direction as the display height and is less than approximately 2.5 times the display height, and the light source has a light source height, at least generally aligned in the direction of the display height, that is less than the lightpipe height.
